(19) United States
(12) Patent Application Publication
(10) Pub. No.: US 2011/0220810 A1
(43) Pub. Date: Sep. 15, 2011

(54) ION DOPING APPARATUS AND DOPING METHOD THEREOF

(75) Inventors: Sun Park, Yongin-city (KR); Chun-Gi You, Yongin-city (KR); Jong-Hyun Park, Yongin-city (KR); Jin-Hee Kang, Yongin-city (KR); Yul-Kyu Lee, Yongin-city (KR)

(73) Assignee: Samsung Mobile Display Co., Ltd., Yongin-city (KR)

(21) Appl. No.: 13/040,795

(22) Filed: Mar. 4, 2011

(30) Foreign Application Priority Data
Mar. 10, 2010 (KR) 10-2010-0021260

(51) Int. Cl. H01J 3/26; H01J 27/02; G21G 5/00

(52) U.S. Cl. 250/400; 250/423 R; 250/492.3

(57) ABSTRACT

An ion doping apparatus and a doping method are disclosed. In one embodiment, the apparatus includes a chamber, and a substrate driving unit configured to support and move a substrate in the chamber, wherein the substrate has a plurality of long sides and a plurality of short sides. The apparatus further includes an ion beam generator configured to generate and provide an ion beam having a width smaller than the length of the short sides of the substrate, wherein the substrate driving unit is further configured to move the substrate substantially perpendicular to the width direction of the ion beam.

### CROSS-REFERENCE TO RELATED APPLICATIONS

This application claims priority to and the benefit of Korean Patent Application No. 10-2010-0021260, filed on Mar. 10, 2010, in the Korean Intellectual Property Office, the entire content of which is incorporated herein by reference.

### BACKGROUND

1. Field

The described technology generally relates to an ion doping apparatus and a doping method of performing ion doping on a large substrate.

2. Discussion of the Related Technology

A variety of flat panel displays that reduce the weight and volume, and other defects of cathode ray tubes, have been developed. Typical flat panel displays include a liquid crystal display, a field emission display, a plasma display panel, and an organic light emitting display etc.

The liquid crystal and field emission displays are classified into a passive matrix type and an active matrix type in accordance with a driving method. The active matrix type includes pixels disposed at the cross points of a plurality of gate lines and data lines arranged across each other on a panel, and at least one thin film transistor disposed in each of the pixels.

### SUMMARY

One aspect is an ion doping apparatus and a doping method implementing a way of dividing and scanning the region of a large substrate when performing ion doping on the large substrate where a plural number cutting method is applied.

Another aspect is an ion doping apparatus that includes: a chamber; a substrate driving unit supporting and moving a substrate in predetermined directions in the chamber; and an ion beam generator generating and providing an ion beam having a width smaller than the short-axis length to the substrate, in which the substrate driving unit moves the substrate perpendicular to the width direction of the ion beam.

The substrate is a large substrate, where the plural number cutting method is applied, having a plurality of divided unit cell regions A therein, and the width of the ion beam may be half the short-axis length of the substrate.

Further, the substrate driving unit includes: a substrate support member that is a plate supporting the substrate; a plurality of rollers arranged in a line to support both ends of the substrate support member; rotary shafts connected with the rollers; and a controller controlling the operation of the rotary shafts.

Further, the controller controls rotation of the rotary shaft and length-directional movement of the rotary shaft.

Further, the ion beam generator includes: at least one filament producing plasma by exciting predetermined gas; a plurality of magnetic substances changing the spiral paths of the ions in the plasma; and a plurality of electrodes accelerating the ions to the substrate, and the predetermined gas is boron or phosphorus.

Another aspect is an ion doping method including: delivering a substrate into a chamber where an ion beam is radiated; positioning the substrate such that a region where the ion beam is radiated corresponds to a first region of the substrate; moving the substrate in the first direction perpendicular to the width direction of the radiated ion beam and sequentially performing ion doping to the first region of the substrate; positioning the substrate such that the region where the ion beam is radiated corresponds to a second region of the substrate, after the ion doping to the first region is finished; and moving the substrate opposite to the first direction and sequentially performing ion doping to the second region of the substrate. Another aspect is an ion doping apparatus comprising: a chamber; a substrate driving unit configured to support and move a substrate in the chamber, wherein the substrate has a plurality of long sides and a plurality of short sides; and an ion beam generator configured to generate and provide an ion beam having a width smaller than the length of the short sides of the substrate, wherein the substrate driving unit is further configured to move the substrate substantially perpendicular to the width direction of the ion beam.

In the above apparatus, the substrate comprises a plurality of divided unit cell regions. In the above apparatus, the substrate has two long sides and two short sides, and wherein the divided unit cell regions comprise a first region and a second region formed in the upper half and lower half of the substrate, respectively.

In the above apparatus, the first and second regions have substantially the same dimension, and wherein the width of the ion beam is substantially the same as the width of the first or second region. In the above apparatus, the width of the ion beam is about half the length of the short sides of the substrate.

In the above apparatus, the substrate driving unit comprises: a substrate support member configured to support the substrate, wherein the substrate support member has two opposing ends; a plurality of rollers spaced apart to support the two ends of the substrate support member; at least one rotary shaft connected to the rollers; and a controller configured to control the operation of the at least one rotary shaft.

In the above apparatus, the controller is positioned outside the chamber and at least part of the rotary shaft is positioned inside the chamber. In the above apparatus, the controller is further configured to control rotation of the rotary shaft and length-directional movement of the rotary shaft.

In the above apparatus, the ion beam generator comprises: at least one filament configured to produce plasma by exciting a predetermined material; a plurality of magnetic substances configured to change the spiral paths of the ions in the plasma; and a plurality of electrodes configured to accelerate the ions to the substrate. In the above apparatus, the predetermined material is boron or phosphorus.

Another aspect is an ion doping method comprising: placing a substrate in a chamber, wherein the substrate has first and second regions; irradiating an ion beam to the substrate, wherein the width of the ion beam is less than the width of the substrate; first moving the substrate in a first direction substantially perpendicular to the width direction of the radiating ion beam so as to perform ion doping on the first region of the substrate; after the ion doping on the first region is completed, second moving the substrate in a direction substantially opposite to the first direction so as to perform ion doping on the second region of the substrate.

The above method further comprises: before the first moving, positioning the substrate to be adjacent to the first region of the substrate; and before the second moving, positioning the substrate to be adjacent to the second region of the substrate.

In the above method, the substrate comprises a plurality of divided unit cell regions. In the above method, the substrate has a plurality of long sides and a plurality of short sides, and wherein the width of the ion beam is about half the length of the short sides of the substrate.

Another aspect is an ion doping apparatus comprising: a chamber; an ion beam generator configured to irradiate an ion beam to a substrate to be ion-doped, wherein the substrate has a plurality of long sides and a plurality of short sides, and wherein the ion beam has a width smaller than the length of the short sides of the substrate; and a driver configured to move the substrate in first and second directions in the chamber, wherein the first and second directions are substantially perpendicular to each other, and wherein one of the first and second directions is substantially perpendicular to the width direction of the ion beam.

In the above apparatus, the substrate has a substantially rectangular shape, and wherein the substrate has a first region and a second region formed in the upper and lower halves thereof, respectively. In the above apparatus, the first and second regions have substantially the same dimension, and wherein the width of the ion beam is substantially the same as the width of the first or second region.

In the above apparatus, the width of the ion beam is about half the length of the short sides of the substrate. In the above apparatus, the driver is further configured to move the substrate in the first direction while an ion beam irradiates one of the first and second regions, and wherein the driver is further configured to move the substrate from the first region to the second region along the second direction.

In the above apparatus, the driver comprises: a substrate support member configured to support the substrate, wherein substrate support member has two opposing ends; a plurality of rollers spaced apart to support the two ends of the substrate support member; at least one rotary shaft connected to the rollers; and a controller configured to control rotation of the rotary shaft and length-directional movement of the rotary shaft.

### BRIEF DESCRIPTION OF THE DRAWINGS

FIG. 1A and FIG. 1B are cross-sectional views of a thin film transistor for driving a pixel in an active matrix type flat panel display.

FIG. 2A and FIG. 2B are cross-sectional views of an ion doping apparatus according to an embodiment.

FIG. 3 is a plan view of the substrate shown in FIG. 1.

FIG. 4A to FIG. 4D are schematic views illustrating an ion doping method according to an embodiment.

FIG. 5 is a cross-sectional view of the ion beam generator shown in FIG. 2A and FIG. 2B.

### DETAILED DESCRIPTION

An active matrix type thin film transistor generally includes an active layer, a gate electrode, and source and drain electrodes. An ion doping process is generally used to form the active layer.

There has been a tendency to increase the size of flat panel displays. Further, recently, a plural number cutting method that manufactures a plurality of sheets from one mother plate has been developed to reduce manufacturing costs and improve the productivity of display substrates.

In typical ion doping apparatuses, a substrate is placed in a chamber and ion doping is performed on the entire substrate. In this situation, the doping apparatus needs to be increased in size to match the increasing size of the substrate. However, this method increases manufacturing costs and requires more space for the manufacturing equipment.

In the following detailed description, only certain exemplary embodiments have been shown and described, simply by way of illustration. As those skilled in the art would realize, the described embodiments may be modified in various different ways. Accordingly, the drawings and description are to be regarded as illustrative in nature and not restrictive. In addition, when an element is referred to as being “on” another element, it can be directly on the another element or be indirectly on the another element with one or more intervening elements interposed therebetween. Also, when an element is referred to as being “connected to” another element, it can be directly connected to the another element or be indirectly connected to the another element with one or more intervening elements interposed therebetween. Hereinafter, like reference numerals refer to like elements.

Before describing an ion doping apparatus and a doping method according to embodiments, the structure of the thin film transistor equipped on an active matrix type flat panel display where the doping process is applied is described.

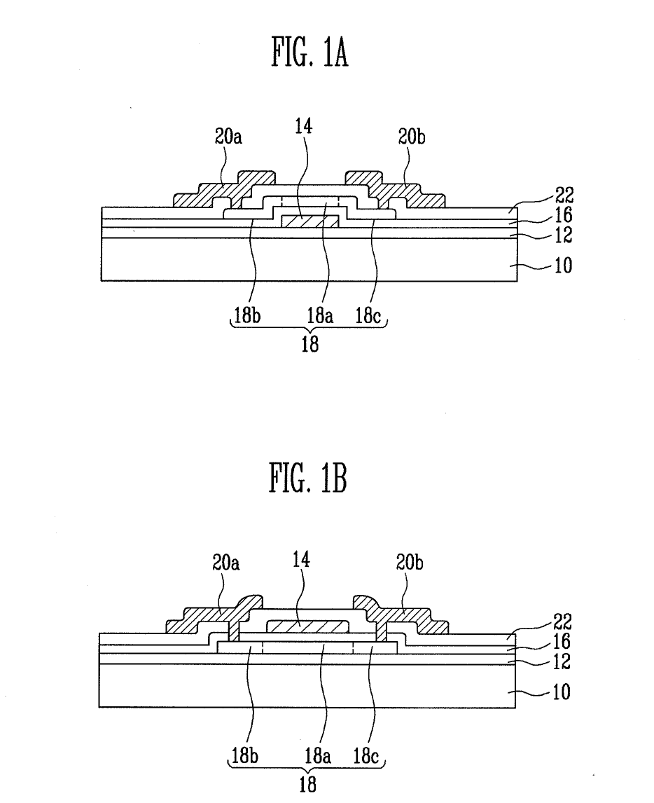

FIG. 1A and FIG. 1B are cross-sectional views of a thin film transistor for driving a pixel in an active matrix type flat panel display.

The thin film transistor shown in FIG. 1A represents an inverted staggered bottom gate structure and the thin film transistor shown in FIG. 1B represents a top gate structure.

Referring to FIG. 1A, a buffer layer 12 is formed on a substrate 10 and a gate electrode 14 is formed on the buffer layer 12.

Thereafter, an insulating film 16 is formed on the buffer layer 12 and the gate electrode 14. A semiconductor layer 18, including i) an active layer providing a channel region 18a, ii) a source region 18b, and iii) a drain region 18c, is formed on the insulating film 16. In one embodiment, the channel region 18a is located substantially directly above the gate electrode 14 as shown in FIG. 1A. The semiconductor layer 18 may be formed of amorphous silicon (a-Si). In one embodiment, the semiconductor layer 18 has a non-linear shape which is similar to that of the insulating film 16.

Further, as shown in FIG. 1A, a passivation layer 22 is formed on the semiconductor layer 18. A via-hole is formed in a predetermined region (the region corresponding to the source and drain regions) of the passivation layer 22. Source and drain electrodes 20a and 20b are formed on the passivation layer and electrically connected to the source and drain regions (18b, 18c) of the semiconductor layer 18, respectively, through the via-hole, such that the thin film transistor, having an inverted staggered bottom gate structure, is manufactured.

A thin film transistor having a top gate structure is shown in FIG. 1B. In this structure, the semiconductor layer 20 is formed between the buffer layer 12 and the insulating film 16. The semiconductor layer 18 may be formed of crystalline silicon (poly-Si). Further, the gate electrode 14 is formed on the insulating film 16. In one embodiment, the gate electrode 14 is substantially directly above the channel region 18a. Further, a via-hole is formed in the insulating film 16 and the passivation layer 22 as shown in FIG. 1B so that the source and drain electrodes 20a and 20b are electrically connected to the source and drain regions (18b, 18c) of the semiconductor layer 18, respectively. In one embodiment, the semiconductor layer 18 has a substantially linear shape as shown in FIG. 1B.

In order to implement the thin film transistor having this configuration, a process of doping with dopant ions, such as boron (B) or phosphorus (P), is additionally applied to the source region 18b and drain region 18c of the semiconductor layer 18, in which an ion doping apparatus is used to form the source and drain regions 18b and 18c by performing ion doping on the semiconductor layer 18.

One embodiment divides and scans the region of a large substrate when performing ion doping on the large substrate to apply a plural number cutting method. Accordingly, it does not need to increase the size of an ion depositing apparatus, even if the substrate increases in area, such that it is possible to minimize the cost for the manufacturing equipment.

Hereinafter, embodiments will be described in detail with reference to the accompanying drawings.

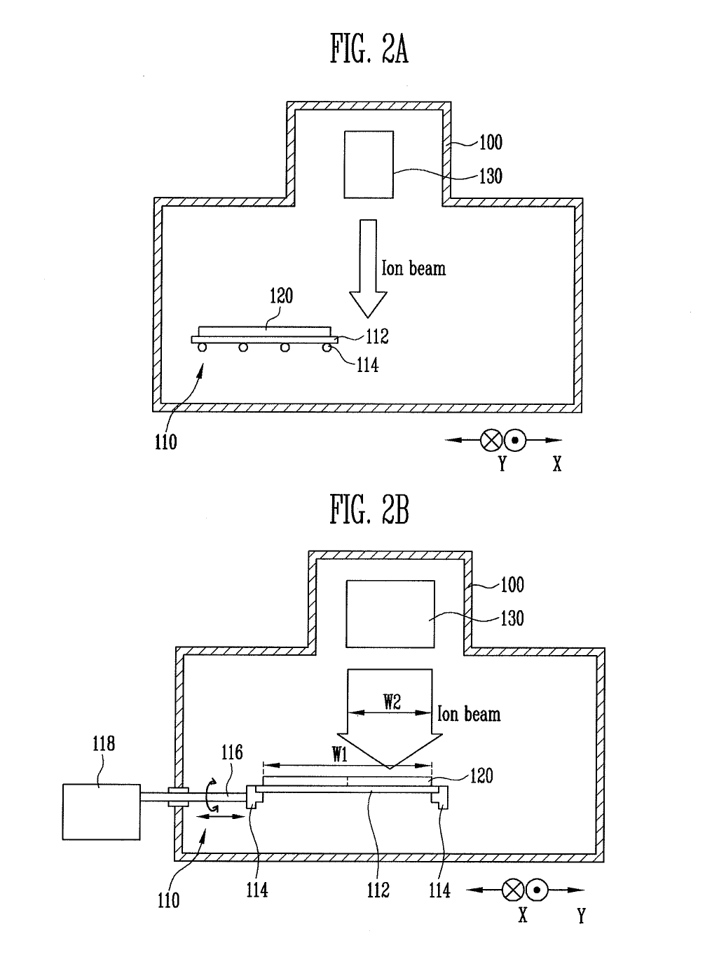

FIG. 2A and FIG. 2B are cross-sectional views of an ion doping apparatus according to an embodiment.

FIG. 2A is a cross-sectional view taken in the long axis of the substrate 120 (e.g. X-axis) and FIG. 2B is a cross-sectional view taken in the short axis of the substrate 120 (e.g. Y-axis).

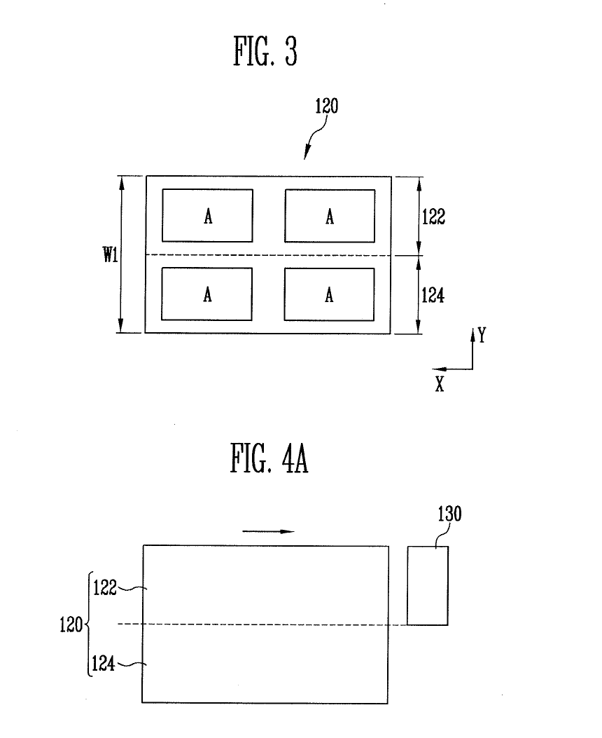

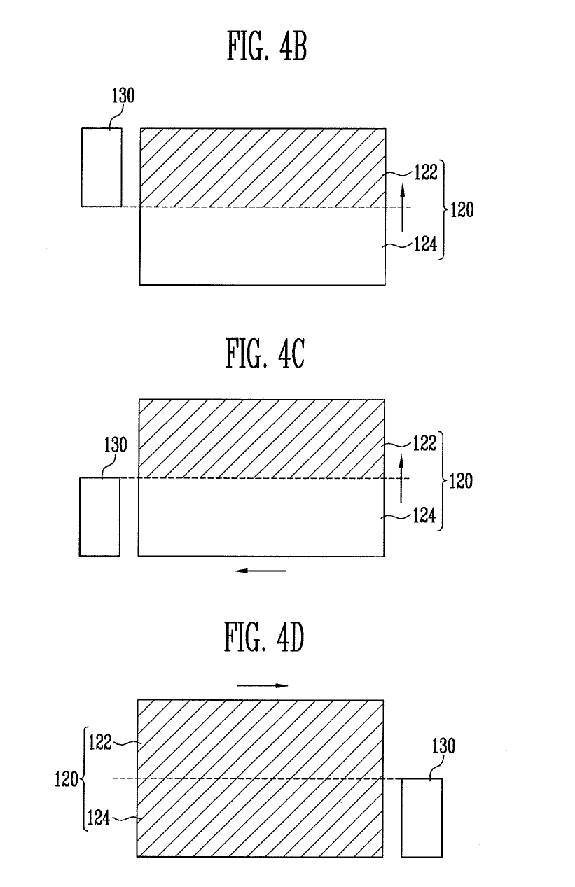

Further, FIG. 3 is a plan view of the substrate shown in FIG. 1, and FIG. 4A to FIG. 4D are schematic views illustrating an ion doping method according to an embodiment.

Referring to FIGS. 2A and 2B, the ion doping apparatus includes: i) a chamber 100, ii) a substrate driving unit 110 for supporting and moving a substrate 120 in predetermined directions in the chamber 100 and iii) an ion beam generator 130 for generating and providing an ion beam to the substrate.

In one embodiment, the substrate 120 is a large substrate in which a plurality of divided unit cell regions A are formed and the ion beam generator 130 radiates an ion beam having a width W2 smaller than the short-axis length W1 (or the length of short sides) of the substrate.

The substrate 120 is, as shown in FIG. 3, divided into a first region 122 and a second region 124 formed in the upper and lower halves of the substrate 120, respectively.

In one embodiment, when the substrate 120 is a rectangle that is long in the X-axis and short in the Y-axis in a plan view, the ion beam generator 130 radiates an ion beam having a width W2 smaller than the width of the short side of the substrate 120, that is, the short-axis length W1. In one embodiment, the width of the ion beam is defined along the Y-axis as shown in FIG. 4A. In another embodiment, the substrate 120 may have a polygonal shape which has a plurality of long sides and a plurality of short sides of the substrate 120. In this embodiment, the width of the ion beam is less than the length of the short sides of the substrate 120.

In one embodiment, the width of the ion beam is about half the short-axis length of the substrate. This is, the width of the ion beam is not limited thereto.

Further, the substrate driving unit 110 reciprocates the substrate 120 in the X direction substantially perpendicular to the width direction of the ion beam (Y direction) to perform ion doping on the entire substrate, using the radiated ion beam.

However, since the width W2 of the ion beam is smaller than the short-axis length W1 of the substrate, as the substrate driving unit 110 reciprocates, one or more regions of the substrate 120 are not irradiated at a given time.

In one embodiment, the region of the substrate 120 to be doped is divided and the divided regions are separately scanned such that it does not need to increase the width of the ion beam, even if the substrate increases in size beyond the width of the ion beam.

A doping method using the division scan technique is described in more detail with reference to FIGS. 4A to 4D.

In one embodiment, the width of the ion beam radiated from the ion beam generator 130 to the substrate 120 is about half the short-axis length of the substrate. In another embodiment, the width of the ion beam may be less or greater than about half the short-axis length of the substrate 120.

The substrate is positioned such that the region where the ion beam is radiated corresponds to the first region 122 of the substrate (FIG. 4A) and then the substrate 120 is moved substantially linearly in the first direction (e.g. from the left to the right).

Thereafter, the first region 122 of the substrate 120 is scanned by the ion beam and the ion doping is sequentially performed along the first region 122 of the substrate 120 (FIG. 4B).

After ion doping is completed on the first region 122, the substrate is moved to the Y-axis direction (e.g. upwardly as shown in FIGS. 4B and 4C) such that the region where the ion beam is radiated corresponds to the second region 124 of the substrate (FIG. 4C). Thereafter, the substrate 120 is moved substantially linearly in the opposite direction (e.g., from right to left) to the first direction.

Thereafter, the second region 124 of the substrate is also scanned by the ion beam and the ion doping is sequentially performed along the second region 124 of the substrate 120 (FIG. 4D).

In the present embodiment, the doping apparatus reciprocates the substrate 120 in the X-axis direction and moves the substrate 120 in the Y-axis direction after doping is completed on the first region 122 of the substrate 120, in order to implement the division scan.

Referring to FIGS. 2A and 2B, the substrate driving unit 110 may include i) a substrate support member 112, which is, for example, a plate for supporting the substrate 120, ii) a plurality of rollers 114 arranged in a line or row to be spaced apart, iii) rotary shafts 116 connected with the rollers 114 and iv) a controller 118 for controlling the operation of the rotary shafts 116.

In one embodiment, the rollers 114 support both ends of the substrate support member 112, and the substrate 120 is reciprocated in the X-axis direction by rotation of the rollers 114. That is, as the rollers 114 rotate clockwise, the substrate 120 moves in the first direction on the X-axis, for example, from left to right Further, as the rollers 114 rotate counterclockwise, the substrate 120 moves opposite to the first direction, that is, for example, from right to left.

Further, when doping on a predetermined region of the substrate 120 is completed while the substrate 120 reciprocates in the X-axis direction, the substrate driving unit 110 moves the substrate in the Y-axis direction, which can be implemented by moving the rotary shafts 116 in the Y-axis direction.

That is, the rotary shafts 116 rotate the rollers 114 connected thereto and change in length, such that they can move the substrate support member 112 in the Y-axis direction.

In one embodiment, the rotation and length adjustment, that is, movement in the length direction, of the rotary shaft 116 are achieved by the controller 118 disposed outside the chamber 100. The controller 118 may include a motor (not shown).

In one embodiment, the rollers 114 connected with the rotary shafts 116 and the other rollers 114, for example, can be linked by a chain or a belt to rotate substantially simultaneously. A vacuum sealing bearing may be provided for the portion where the rotary shaft 116 passes through the chamber 110.

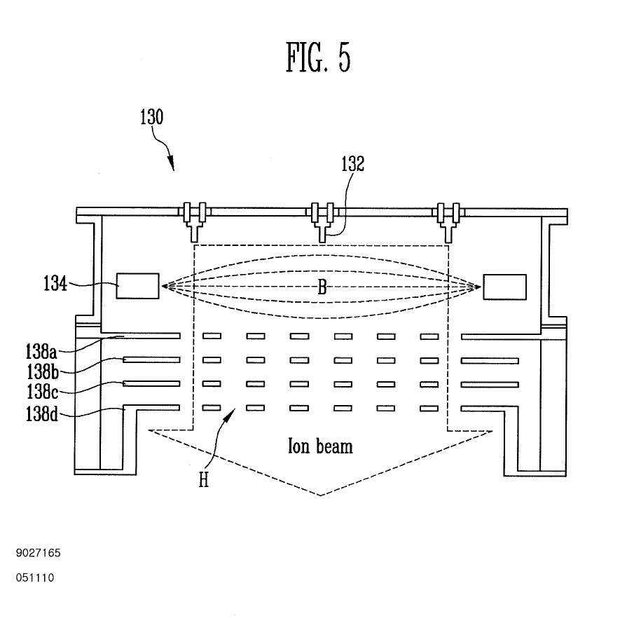

FIG. 5 is a cross-sectional view of the ion beam generator shown in FIGS. 2A and 2B.

The ion beam generator 130 shown in FIG. 5, however, is merely one embodiment and can have other configurations.

In one embodiment, the ion beam generator 130 ionizes a desired dopant component into plasma state and produces an ion beam by accelerating the component to a doping region, that is, the substrate. In one embodiment, the ion beam generator 130 includes i) one or more filaments 132 that create plasma by exiting material, such as boron or phosphorus, ii) a plurality of magnetic substances 134 that improve uniformity by changing the spiral paths of the ions in the plasma and removing predetermined polar ions, such as hydrogen (H), and iii) a plurality of electrodes 138a, 138b, 138c, and 138d that accelerate the ions to the substrate.

In one embodiment, the magnetic substances 134 create a magnetic field B substantially perpendicularly crossing the movement direction of the ions. Further, a plurality of permanent magnets are disposed in the ion beam generator 130, particularly, arranged around between the filaments and electrodes 136. In one embodiment, the electrodes 138a, 138b, 138c, and 138c have a plurality of up-down through holes H to pass the ions.

Therefore, the ions, which are produced by the filaments 132, controlled in uniformity by the magnetic substances 134, and accelerated to the substrate 120 through the electrodes 138a, 138b, 138c, and 138d, are embedded into the surface of an intrinsic semiconductor layer.

According to at least one embodiment, the size of an ion deposition apparatus does not need to be increased, even if a substrate increases in area, by implementing a way of dividing and scanning separate regions of the large substrate when performing ion doping on a large substrate where a plural number cutting method is applied.

While the present invention has been described in connection with certain exemplary embodiments, it is to be understood that the invention is not limited to the disclosed embodiments, but, on the contrary, is intended to cover various modifications and equivalent arrangements included within the spirit and scope of the appended claims, and equivalents thereof.

What is claimed is:

1. An ion doping apparatus comprising:
a chamber;
a substrate driving unit configured to support and move a substrate in the chamber, wherein the substrate has a plurality of long sides and a plurality of short sides; and
an ion beam generator configured to generate and provide an ion beam having a width smaller than the length of the short sides of the substrate,
wherein the substrate driving unit is further configured to move the substrate substantially perpendicular to the width direction of the ion beam.

2. The ion doping apparatus as claimed in claim 1, wherein the substrate comprises a plurality of divided unit cell regions.

3. The ion doping apparatus as claimed in claim 2, wherein the substrate has two long sides and two short sides, and wherein the divided unit cell regions comprise a first region and a second region formed in the upper half and lower half of the substrate, respectively.

4. The ion doping apparatus as claimed in claim 3, wherein the first and second regions have substantially the same dimension, and wherein the width of the ion beam is substantially the same as the width of the first or second region.

5. The ion doping apparatus as claimed in claim 1, wherein the width of the ion beam is about half the length of the short sides of the substrate.

6. The ion doping apparatus as claimed in claim 1, wherein the substrate driving unit comprises:
a substrate support member configured to support the substrate, wherein the substrate support member has two opposing ends;
a plurality of rollers spaced apart to support the two ends of the substrate support member;
at least one rotary shaft connected to the rollers; and
a controller configured to control the operation of the at least one rotary shaft.

7. The ion doping apparatus as claimed in claim 6, wherein the controller is positioned outside the chamber, and wherein at least part of the rotary shaft is positioned inside the chamber.

8. The ion doping apparatus as claimed in claim 6, wherein the controller is further configured to control rotation of the rotary shaft and length-directional movement of the rotary shaft.

9. The ion doping apparatus as claimed in claim 1, wherein the ion beam generator comprises:
at least one filament configured to produce plasma by exciting a predetermined material;
a plurality of magnetic substances configured to change the spiral paths of the ions in the plasma; and
a plurality of electrodes configured to accelerate the ions to the substrate.

10. The ion doping apparatus as claimed in claim 6, wherein the predetermined material is boron or phosphorus.

11. An ion doping method comprising:
placing a substrate in a chamber, wherein the substrate has first and second regions;
irradiating an ion beam to the substrate, wherein the width of the ion beam is less than the width of the substrate;
first moving the substrate in a first direction substantially perpendicular to the width direction of the radiating ion beam so as to perform ion doping on the first region of the substrate;
after the ion doping on the first region is completed, second moving the substrate in a direction substantially opposite to the first direction so as to perform ion doping on the second region of the substrate.

12. The ion doping method as claimed in claim 11, further comprising:
before the first moving, positioning the substrate to be adjacent to the first region of the substrate; and
before the second moving, positioning the substrate to be adjacent to the second region of the substrate.

13. The ion doping method as claimed in claim 11, wherein the substrate comprises a plurality of divided unit cell regions.

14. The ion doping method as claimed in claim 11, wherein the substrate has a plurality of long sides and a plurality of short sides, and wherein the width of the ion beam is about half the length of the short sides of the substrate.

15. An ion doping apparatus comprising:
a chamber;
an ion beam generator configured to irradiate an ion beam to a substrate to be ion-doped, wherein the substrate has a plurality of long sides and a plurality of short sides, and wherein the ion beam has a width smaller than the length of the short sides of the substrate; and
a driver configured to move the substrate in first and second directions in the chamber, wherein the first and second directions are substantially perpendicular to each other, and wherein one of the first and second directions is substantially perpendicular to the width direction of the ion beam.

16. The ion doping apparatus as claimed in claim 15, wherein the substrate has a substantially rectangular shape, and wherein the substrate has a first region and a second region formed in the upper and lower halves thereof, respectively.

17. The ion doping apparatus as claimed in claim 16, wherein the first and second regions have substantially the same dimension, and wherein the width of the ion beam is substantially the same as the width of the first or second region.

18. The ion doping apparatus as claimed in claim 15, wherein the width of the ion beam is about half the length of the short sides of the substrate.

19. The ion doping apparatus as claimed in claim 15, wherein the driver is further configured to move the substrate in the first direction while an ion beam irradiates one of the first and second regions, and wherein the driver is further configured to move the substrate from the first region to the second region along the second direction.

20. The ion doping apparatus as claimed in claim 15, wherein the driver comprises:
a substrate support member configured to support the substrate, wherein substrate support member has two opposing ends;
a plurality of rollers spaced apart to support the two ends of the substrate support member;
at least one rotary shaft connected to the rollers; and
a controller configured to control rotation of the rotary shaft and length-directional movement of the rotary shaft.
